(19) United States
(12) Patent Application Publication
(10) Pub. No.: US 2021/0363390 A1
(43) Pub. Date: Nov. 25, 2021

(54) PRESSURE-SENSITIVE STRUCTURAL ADHESIVE FILM BASED ON EPOXY RESIN COMPOSITION

(71) Applicant: Lohmann GmbH & Co. KG, Neuwied (DE)

(72) Inventors: Ruben FRIEDLAND, Andernach (DE); Maximilian WELTEROTH, Eitorf (DE)

(73) Assignee: Lohmann GmbH & Co. KG, Neuwied (DE)

(21) Appl. No.: 17/040,689

(22) PCT Filed: Mar. 23, 2018
(86) PCT No.: PCT/EP2018/057550

§ 371 Date: Sep. 23, 2020

(51) Int. Cl. C09J 7/38; C09J 7/10; C09J 7/21

(52) U.S. Cl. CPC C09J 7/38; C09J 7/10; C09J 7/21; C09J 2301/302; C09J 2483/006; C09J 2400/283; C09J 2463/00

(57) ABSTRACT

A pressure-sensitive structural adhesive film based on an epoxy resin composition, the epoxy resin composition having latent reactive, thermally activatable curing agent for producing a structural composite after thermal curing. The epoxy resin composition also comprises a curing agent that crosslinks at room temperature.

### CROSS-REFERENCE TO RELATED APPLICATIONS

This application is a national stage U.S. patent application of International Application No. PCT/EP2018/057550, filed Mar. 23, 2018, the entirety of which is incorporated herein by reference.

### TECHNICAL FIELD

The present disclosure relates to a pressure-sensitive adhesive film based on a latent reactive composition, which is thermally activated and crosslinked and which is adhesive at room temperature in its non-cured state.

The terminology used in the descriptions below is to be understood as follows:

“Latent reactive adhesive film” means an adhesive film, where the curing is effected by applying heat. The curing agent is provided in the adhesive film, but it only becomes active when the temperature rises or once a certain temperature has been reached.

“Adhesive film” hereinafter relates to any type of spatial adhesive systems, i.e. not only adhesive films but also adhesive tapes, adhesive foils, adhesive strips, adhesive plates or adhesive stamped parts. Moreover, the term “adhesive tape” or “adhesive film” shall also comprise what is referred to as “transfer films”, i.e. adhesive tapes without backing.

The terms “pressure-adhesive” or “pressure”-adhesive compounds are used for adhesive compounds or adhesive films that are capable of creating a bond between two join partners simply by applying pressure. In particular, also subject to relatively mild contact pressure, a durable bond with the join partner can be achieved. The bond is reversible, i.e. it can be reversed without destroying the join partners.

“Structural” or “semi-structural” adhesive bonds refer to bonds exhibiting a bond strength of >2 MPa on all conventional substrates (e.g. aluminium, steel, GFK, CFK).

### DESCRIPTION OF RELATED TECHNOLOGY

In the majority of cases, epoxy resin adhesives based on liquid adhesives are used for structural and semi-structural adhesive bonding of components (e.g. in automotive shell construction). They are applied using complex controlled dynamic or static dosage devices. The liquid adhesives are associated with the disadvantage that they provide no initial strength (also referred to as initial adhesive strength) so that the components to be joined have to be mechanically held in position during curing. This is for example achieved using welding spots or clamps.

Pressure-adhesive tapes keep the components in place immediately after joining, thus overcoming the aforementioned disadvantage of the liquid adhesives. They are reversible, i.e. repeated repositioning is still possible. Special types of these adhesive tapes may subsequently be subjected to a curing process during which they develop their final performance in terms of strength and durability. Curing is triggered using UV light, increased temperature or humidity. The curing is irreversible, so that subsequent repositioning is no longer possible.

WO 2015/011686 A1 describes an adhesive tape that can be used on oiled surfaces. However, this particular thermally cross-linking system exhibits no pressure-adhesive properties at room temperature so that the components must be mechanically secured until final curing of the adhesive film.

Pressure-sensitive adhesive films based on epoxy resin for adhesively joining mirror bases to windscreens are described in U.S. Pat. No. 5,587,236. This system is however not suitable for adhesion on oiled surfaces.

Systems using thermoplastic film formers for producing a pressure-sensitive adhesive film based on epoxy resin that is functional at room temperature is for example described in WO 2017/109011. The limited layer thicknesses due to the production method constitutes a disadvantage of this type of adhesive films.

### SUMMARY

It is one object of the present invention to provide an improved pressure-sensitive adhesive film that exhibits pressure-sensitive adhesive properties at room temperature and that can be employed on oiled surfaces and that exhibits high strength after curing (e.g. >10 MPa in tensile shear tests using steel) as well as high resilience vis-à-vis environmental influences.

It is a further object to provide a pressure-sensitive adhesive film that can be produced without the use of film formers and solvents.

The object specified above is achieved by a pressure-sensitive structural adhesive film as described herein.

### DETAILED DESCRIPTION OF EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art.

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it may. Furthermore, the phrase “in another embodiment,” “in a further embodiment,” “in a further development,” “in another development” and so on as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references.

Described is a pressure-sensitive structural adhesive film based on an epoxy resin composition, whereas the epoxy resin composition comprises a latent reactive, thermally activatable curing agent for producing a structural composite after thermal curing. The epoxy resin composition additionally comprises a curing agent that crosslinks at room temperature.

Using at least one curing agent that crosslinks at room temperature allows for the production of a pre-polymer or, in this case, of a pressure-sensitive spatial adhesive composite in the form of an adhesive tape, regardless of the layer thickness, without using a film former or anything similar. Moreover, acrylates and hotmelts can be dispensed with. Also, the adhesive film in hand exhibits thermal post-crosslinking potential.

Consequently, it is possible to obtain manufacture of an adhesive film through partial cross-linking of the epoxy groups using the curing agent that cross-links at room temperature. In particular, the manufacture of the adhesive film and the concurrent increase of viscosity and gelling of the polymer is not achieved by drying and/or UV polymerisation of acrylate groups but by pre-cross-linking of the epoxy resins and producing the pre-polymers from these epoxy resins. This partial reaction is analogous to the cross-linking reaction of a two-component liquid adhesive based on epoxy resin, however, unlike in that reaction, it is presently not finalised thanks to the sub-stoichiometrical addition of the curing agent that cross-links at room temperature. Hence, there remains some reaction potential that can be harnessed in the final application for developing bond strength following thermal curing.

In an embodiment, the epoxy resin composite comprises 30 to 95% by weight of at least one epoxy component, 0.1 to 80% by weight of at least one thermally activatable curing agent, 0.1 to 90% by weight of at least one curing agent that crosslinks at room temperature, 0 to 70% by weight of at least one accelerant, and 0 to 70% by weight of at least one additive, whereas the % by weight of the components add up to 100%.

In another embodiment, the curing agent that crosslinks at room temperature comprises at least one amine, amide and/or thiol. For example, primary or secondary amines, aliphatic amines, aromatic amines, polyamides, amidoamines, jeffamines, poly-thiols or mixtures of the above can be used. Depending on the curing agent that cross-links at room temperature, also other properties of the adhesive films can be influenced, such as for example their tensile strength.

A curing agent based on amine, amide and/or thiol allows for providing a spatial adhesive composite that is flexible and pressure-sensitive when in a non-cured state that is easy to handle and that prevents slipping of the components after bonding until final curing due to its pressure-sensitive adhesive property.

In another embodiment, a pressure-sensitive adhesive film provides adhesive strength of at least 0.2 N/mm in its non-cured state. The adhesive strength is determined on steel in reference to DIN EN 1939:1996 at 23° C.±2° C. and 50%±5% relative humidity at a peel-off speed of 300 mm/min and a peel-off angle of 180°. For the test, an etched PET foil with a thickness of 50 μm is used as a backing film. The test strip with a width of 25 mm is applied to the steel substrate using an application roller at 5 kg and a temperature of 23° C.±2° C. The adhesive film is peeled off 10 minutes after application at 300 mm/min. The measurement value (in N/mm) is a mean value of five individual measurements.

Pressure-sensitive adhesive composites are permanently pressure-sensitively adhesive, i.e. they exhibit sufficiently low viscosity and high initial adhesive strength so that they will wet the surface of the respective adhesion substrate already when subjected only to little pressure. The adhesion capacity of the adhesive composites is based on their adhesive property and their releasability is based on their cohesive properties.

In another embodiment, the pressure-sensitive structural adhesive film includes at least one backing. If a backing material is provided, it may be provided with a (pressure-sensitive) adhesive composite on one side or preferably on both sides, which includes the solvent-free and film formers-free composition, or is made thereof. The backing material comprises all spatial objects such as for example films, foams, tissues, fabrics, non-woven fabrics and papers or also combinations thereof. In this context, different backings can be combined with the adhesive composites for different applications.

In yet another further development, the pressure-sensitive structural adhesive tape has no backing and is thus suitable for forming a transfer film.

In a transfer film or a transfer adhesive tape, the adhesive composite that corresponds to the finished adhesive film in its final state is applied to a flexible liner or between two flexible liners prior to application. The liners are equipped with a separating layer and/or they exhibit anti-adhesive properties.

When two liners are used, for application of the adhesive film, one liner is removed first, and then the adhesive film with the now exposed adhesive surface is applied on a first join partner. Subsequently, the second liner is removed and the adhesive surface now exposed is joined to the second join partner. The adhesive composite can thus be used directly for joining two surfaces.

Such a pressure-sensitive transfer adhesive tape without backing allows for very precise adhesive application in respect of positioning and dosage.

Also adhesive films or adhesive tapes are feasible where just a single liner that is repellent on both sides is used instead of two liners. In this context, a first side of the adhesive film is covered with one side of the liner equipped with a repellent agent on both sides and a second side of the adhesive film is covered with the backside of the liner equipped with a repellent agent on both sides when it is wound onto a roll or a coil.

In a further development, the thickness of the latent reactive pressure-sensitive adhesive composite, both in the form of a transfer adhesive film and coated on a spatial object, amounts to 1 μm and 3000 μm, more preferably 10 μm and 2000 μm and particularly preferably between 50 μm and 1000 μm.

Layer thicknesses between 300 μm and 1000 μm are particularly suited for covering tolerances in the join partners to be bonded and are therefore preferably used in automotive shell construction.

Layer thicknesses between 1 μm and 50 μm result in reduced adhesion to the join partners but will at the same time reduce material consumption.

Epoxy Component

It is provided that the latent reactive composition include at least one epoxy component A. Any epoxy raisin or any material including epoxy known to the skilled person as suitable for use in adhesives and adhesive tapes can be used as the epoxy component. These are random organic compounds including at least one oxirane ring that can be polymerised by way of a ring opening reaction. Such materials comprise both monomers and polymer epoxies and they can be aliphatic, cycloaliphatic and aromatic. The materials referred to as epoxies generally on average have at least two epoxy groups per molecule, preferably more than two epoxy groups per molecule. What is crucial for the subsequent stoichiometric cross-linking of the epoxy groups with the respective cross-linking agent is the epoxy equivalent weight (EEW, Epoxy Equivalent Weight). The EEW provides the mass in [g] of epoxy resin that possesses an equivalent [Eq] of epoxy functions. It is calculated according to the following formula:

$$E E W [ \frac{g}{E q} ] = \frac{{M}_{Epoxy} [ \frac{g}{m o l} ]}{{f}_{Epoxy} [ \frac{E q}{m o l} ]}$$

M_{Epoxy} as the molecular mass of the epoxy resin
f_{Epoxy} as the functionality of the epoxy

The polymer epoxies comprise linear polymers with terminal epoxy groups, polymers with structural oxirane units and polymers with epoxy lateral groups. Useful epoxies of this type are described in detail in U.S. Pat. No. 3,117,099.

Further materials containing epoxy comprise glycidyl thermo-monomers. Those are described in detail in U.S. Pat. No. 3,018,262.

A large number of commercially available materials containing epoxy and epoxy resins can be used. The following readily available epoxies are considered as particularly suitable, such as octadecylenoxide, epichlorohydrin, styrene oxide, vinylcyclohexenoxide, glycidol, glycidyl methacrylate, diglycidyl ether of bisphenol A (e.g. those offered under the trade names EPON 828, EPON 1004 and EPON 1001F by Shell Chemical Co. and DER-332 and DER-334 by Dow Chemical Co.), diglycidyl ether of bisphenol F (e.g. ARALDITE GY281 by Ciba-Geigy), vinylcyclohexendioxide (e.g. ERL 4206 by Union Carbide Corp.), 3,4-epoxycyclohexylmethyl-3,4-epoxycyclohexencarboxylate (e.g. ERL-4221 by Union Carbide Corp.), 2-(3, 4-epoxycyclohexyl-5,5-spiro-3,4-epoxy)cyclohexane-metadioxane (e.g. ERL-4234 by Union Carbide Corp.), bis(3,4-epoxycyclohexyl)adipate (e.g. ERL-4299 by Union Carbide Corp.), dipentendioxide (e.g. ERL-4269 by Union Carbide Corp.), epoxidized polybutadiene (e.g. OXIRON 2001 by FMC Corp.), silicone resin containing epoxy functionality, epoxy silane (e.g. beta-(3,4-epoxycyclohexyl)ethyltrimethoxy silane and gamma-glycidoxypropyltrimethoxysilane, commercially available by Union Carbide), fire-resistant epoxy resins (e.g. DER-542, a brominated bisphenol type epoxy resin, offered by Dow Chemical Co.), 1,4-butandioldiglycidylether (e.g. ARALDITE RD-2 by Ciba-Geigy), hydrated epoxy resins based on bisphenol A-epichlorohydrin (e.g. EPONEX 1510 by Shell Chemical Co.) and polyglycidylether of phenol formaldehyde novolac (e.g. DEN-431 and DEN-438 by Dow Chemical Co.).

In an embodiment, the pressure-sensitive structural adhesive film comprises at least 10% by weight of epoxy resins liquid at 25° C. in respect of the epoxy component A. The share of liquid epoxy resins in the epoxy component A in particular amounts from 10% by weight to 100% by weight, further preferably from 20% by weight to 95% by weight. A liquid epoxy resin or a mixture of different resins can be used.

Thermally Activatable Curing Agent

All known curing agents for epoxy resin adhesives are suitable as thermally activatable curing agents B, for example dicyandiamide, anhydride and mixtures thereof.

Curing Agent that Cross-Links at Room Temperature

All known curing agents for epoxy resin adhesives are suitable as curing agents that cross-link at room temperature C, for example primary or secondary amines, aliphatic amines, aromatic amines, polyamides, amidoamines, jeffamines, phenalkamines, phenalkamides, polythiols or mixtures thereof. A selection of cross-lining agents is for example listed in the textbook “Formulierung von Kleb-und Dichtstoffen” [formulation of adhesive and sealants] by Bodo Müller and Walter Rath (Müller & Rath, 2009)

Accelerants

All known accelerants for epoxy resin adhesives and adhesive tapes are suitable as accelerants D, for example imidazoles, urea derivatives (e.g. monuron, diuron, fenuron), tertiary amines or mixtures thereof. A selection of accelerants is for example listed in the textbook “Formulierung von Kleb- and Dichtstoffen” [formulation of adhesive and sealants] by Bodo Müller and Walter Rath (Müller & Rath, 2009)

Additives

All known additives for adhesive tapes and pressure-sensitive adhesive composites are suitable as additives E, such as for example tackifiers, polymers, rheology modifiers, foaming agents, fillers, adhesion promoters, polyols, anti-oxidants, UV-protectors, UV-stabilisers, dyes, impact resistance modifiers, phenoxy resins or mixtures thereof. Moreover, all additives can be used that are already listed in patent application WO 2017/174303 A1.

Generally, the epoxy resin based adhesive films described herein can be produced using the three methods listed below:

a) Dissolving the epoxy resins, cross-linking agents, suitable film formers and optional additives in water or a solvent. Subsequent coating of this mixture and production of a sheet-shaped adhesive film by drying the adhesive composite.

a) Melting the epoxy resins, cross-linking agents, suitable film formers and optional additives and mixing of the individual components. Subsequently, the heated mass is coated and the sheet-shaped adhesive film is created by cooling down to room-temperature.

c) Mixing of the epoxy resins, the cross-linking agents and optional additives in acrylate monomers equipped with photo initiators. The adhesive film is created by coating and polymerisation of the acrylate.

Described hereinafter are embodiments.

Raw materials used:

| | |
|---|---|
| D.E.R. 671 | Solid epoxy resin based on bisphenol-A- |
| | diglycidylether with an epoxy equivalent weight of |
| | 475-550 g/Eq, a softening temperature of 75-85° C. |
| | and an epoxy group content of 1820-2110 mmol/kg by |
| | the company DOW Chemical Co. |
| D.E.R. 331 | Epoxy resin based on bisphenol-A-diglycidylether with |
| | an epoxy equivalent weight of 182-192 g/Eq by the |
| | company DOW Chemaical Co. |
| D.E.R. 736 | Epoxy resin based on propylene glycol diglycidylether |
| | with an epoxy equivalent weight of 175-205 g/Eq by |
| | the company DOW Chemical Co. |
| Struktol | Nitrile caoutchouc modified epoxy resin based on |
| Polydis 3695 | bisphenol-A-diglycidylether with an epoxy equivalent |
| | weight of 195 g/Eq by the company Schill + Seilacher |
| | “Struktol”. |
| Struktol | Nitrile caoutchouc modified epoxy resin based on |
| Polydis 3614 | bisphenol-A-diglycidylether with an elastomer content |
| | of 40% and an epoxy equivalent weight of 330 g/Eq |
| | by the company Schill + Seilacher “Struktol”. |
| Flexibilizer | Phenol terminated polyurethane adduct with viscosity |
| DY 965 CH | at 40° C. von 440-1280 Pa · s by the company |
| | Huntsman. |
| HyPox | Nitrile caoutchouc modified epoxy resin based on |
| RA 1340 | bisphenol-A-diglycidylether with an elastomer content |
| | of 40% and an epoxy equivalent weight of 350 g/Eq |
| | by the company CVC Thermoset Specialties, Inc. |
| Dyhard 100 S | Latent curing agent for hot-curing epoxy resin |
| | formulations based on dicyandiamide with an amine |
| | equivalent weight of 12-14 g/Eq by the company |
| | AlzChem Group AG. |
| TCD diamine | Low-viscosity tricyclodecane diamine for epoxy resin |
| | formulations that cure at room temperature with an |
| | amine equivalent weight of 48 g/Eq by the company |
| | OXEA Chemicals. |
| Ancamine 2432 | Modified aliphatic amine for epoxy resin formulations |
| | that cure at room temperature with an amine |
| | equivalent weight of 88 g/Eq by the company EVONIK |
| | Industries. |
| Ancamine 2609 | Aliphatic poly-amine for epoxy resin formulations that |
| | cure at room temperature with an amine equivalent |
| | weight of 75 g/Eq by the company EVONIK Industries. |
| Cardolite | Phenalkamide curing agent for epoxy resin |
| LITE 3040 | formulations that cure at room temperature with an |
| | amine equivalent weight of 118 g/Eq by the company |
| | CARDOLITE Corp. |
| Cardolite | Phenalkamine curing agent for epoxy resin |
| NX-5607 | formulations that cure at room temperature with an |
| | amine equivalent weight of 95 g/Eq by the company |
| | CARDOLITE Corp. |
| Dyhard | Di-functional, latent, micronised uron accelerant |
| UR 500 | based on substituted urea by the company AlzChem |
| | Group AG. It is preferably used as a latent accelerant |
| | with latent curing agents for hot-curing epoxy resin |
| | formulations. |
| Aerosil R202 | Pyrogenic silica by the company EVONIK Industries. |

Production of the Pressure-Sensitive Adhesive Composites

For producing the respective pressure-sensitive composites, the respective solid resins on epoxy resin basis are dissolved in the liquid resins on epoxy resin basis as provided subject to stirring at 23° C. Then, optionally the modified epoxy resins and the fillers are added. Subsequently, the thermally activatable curing agent and optionally the accelerant are stirred into the resin composite.

For producing the adhesive composite layers, i.e. the (pressure-sensitive) adhesive tapes without backing, the different adhesive composites are mixed with different concentrations of the curing agent that cross-links at room temperature and applied to a conventional liner (siliconized polyester film) using a laboratory coating device and pre-cross-linked. After pre-cross-linking, the thickness of the transfer film amounts to 200±15 μm. In analogy to drying a solvent-based adhesive film, pre-cross-linking is first effected for ten minutes at room temperature and subsequently for 10 minutes at 80° C. Immediately after pre-cross-linking, the pre-cross-linked adhesive films are each laminated to a second liner (siliconized paper with less separating force than the first liner) on the exposed side.

An aspect of the production of this transfer film consists in the generation of what is referred to as a pre-polymer by cross-linking only part of the reactive groups of the epoxy resins used with the curing agent that cross-links at room temperature. This means that only when the substrates are finally bonded and following down-stream thermal curing, the other reactive groups are cross-linked and a structural adhesive bond is created.

Composition of the Adhesive Composites

In the following table, the compositions of the adhesive tapes are summarised in respect of the selection of the curing agent that cross-links at room temperature, with the volume specifications indicating part by weight:

| Example: | | K1 | K2 | K3 | K4 |
|---|---|---|---|---|---|
| Epoxy | D.E.R. 671 | 20 | 20 | 20 | 20 |
| component | D.E.R. 331 | 60 | 60 | 60 | 60 |
| | D.E.R. 736 | 55 | 55 | 55 | 55 |
| Thermally | Dyhard 100S | 7.3 | 7.3 | 7.3 | 5.0 |
| activatable | | | | | |
| curing agent | | | | | |
| Curing agent | TCD diamine | | | 4.8 | |
| that cross- | Ancamine 2432 | 8.7 | | | |
| links at room | Ancamine 2609 | | 7.4 | | |
| temperature | Cardolite LITE | | | | 31.9 |
| | 3040 | | | | |
| Accelerant | Dyhard UR 500 | 3.7 | 3.7 | 3.7 | 2.5 |
| Additive | Aerosil R202 | 2.0 | 2.0 | 2.0 | 2.0 |

In the following table, the compositions of the adhesive tapes are summarised in relation to the addition of epoxy components, with the volume specifications indicating part by weight:

| Example: | | K5 | K6 | K7 | K8 | K9 |
|---|---|---|---|---|---|---|
| Epoxy | D.E.R. 671 | 20 | 20 | 20 | 20 | 20 |
| component | D.E.R. 331 | 60 | 60 | 60 | 60 | 60 |
| | D.E.R. 736 | 55 | 55 | 55 | 55 | 55 |
| | Struktol Polydis | | 27 | 27 | 27 | 27 |
| | 3695 | | | | | |
| | Struktol Polydis | | 15 | 15 | 77 | 77 |
| | 3614 | | | | | |
| | Flexibilizer DY | 9 | 11 | 15 | 15 | 15 |
| | 965 | | | | | |
| | HyPox RA 1340 | | | 62 | | |
| Thermally | Dyhard 100S | 5.2 | 6.6 | 8.0 | 8.1 | 8.1 |
| activatable | | | | | | |
| curing agent | | | | | | |
| Curing agent | Ancamine 2609 | 20.7 | 26.5 | 32.1 | 32.5 | |
| that cross- | Cardolite NX- | | | | | 41.1 |
| links at room | 5607 | | | | | |
| temperature | | | | | | |
| Accelerant | Dyhard UR 500 | 2.6 | 3.3 | 4.0 | 4.0 | 4.0 |
| Additive | Aerosil R202 | 2.0 | 2.0 | 2.0 | 2.0 | 2.0 |

Results of the pressure-adhesive composites regarding adhesive strength, tensile shear strength and tensile strength.

Adhesive Strength:

The adhesive strength is determined on steel in reference to DIN EN 1939:1996 at 23° C.±2° C. and 50%±5% relative humidity at a peel-off speed of 300 mm/min and a peel-off angle of 180°. An etched PET foil with a thickness of 50 μm is used as a reinforcement foil. The test strip with a width of 25 mm is applied to the steel substrate using an application roller at 5 kg and a temperature of 23° C.±2° C. The adhesive film is peeled off 10 minutes after application at 300 mm/min. The measurement value (in N/mm) is a mean value of five individual measurements including standard deviation.

Tensile Shear Strength:

In order to determine parameters for the adhesive strength on steel, tensile shear tests are carried out according to DIN EN 1465 at 23° C.±2° C. and 50%±5% relative humidity at a testing speed of 10 mm/min. 1,4301 alloy steels are used as test substrates, and they are first cleaned with acetone and then subjected to mechanical surface preparation using cross-grinding. The samples are each cured for 30 minutes at 130° C. The results are indicated in MPa (N/mm²). The figures stated are the mean value based on five measurements including standard deviation and failure pattern evaluation.

Tensile Strength:

In order to determine parameters for the strength of the adhesive film in its cured state, tensile tests are carried out according to DIN EN ISO 527 at 23° C.±2° C. and 50%±5% relative humidity at a testing speed of 10 mm/min. To this end, strips of a width of 15 mm and of a length of 100 mm are cut out of cured adhesive films. In the results illustrated, the layer thickness amounts to 0.2 mm. The samples are cured for 30 minutes at 130° C. The results are indicated in MPa (N/mm²). The figures stated are the mean value based on five measurements including standard deviation.

The following table summarises the results of the adhesive strength measurements, the tensile shear tests and the tensile tests of the adhesive films.

| Example: | K1 | K2 | K3 | K4 |
|---|---|---|---|---|
| Adhesive | 0.11 ± 0.04 | 0.64 ± 0.11 | 0.72 ± 0.06 | 0.51 ± 0.02 |
| strength | (AF/CF) | (AF/CF) | (AF/CF) | (SCF/CF) |
| [N/mm] | | | | |
| Tensile shear | 11 ± 2 (AF) | 20 ± 2 (AF) | 22 ± 2 (AF) | 20 ± 3 (AF) |
| strength [MPa] | | | | |
| Tensile | 59 ± 6 | 62 ± 1 | 62 ± 1 | 46 ± 1 |
| strength [MPa] | | | | |

Key: AF: adhesion failure; CF: cohesion failure; SCF: substrate-related special cohesion failure; noF: no failure as the force limit of the test device was reached.

Adhesive films K1 through K4 are of similar composition. Only the curing agent that cross-links at room temperature is varied to illustrate differences in the selection of that agent.

The adhesive films with the adhesive composites K2 and K3 show no significant differences in terms of adhesive strength in the non-cured state within the range of the standard deviation. The adhesive composite K1 with the modified aliphatic cross-linking agent exhibits higher cohesion in the non-cured state and thus less adhesion, which manifests in the significantly reduced adhesive strength. In adhesive composite K4, a phenalkamide was used as the curing agent that cross-links at room temperature, which results in reduced cohesion in the non-cured state, which manifests in the change of failure patterns in the determination of adhesive strength.

The tensile shear test showed no significant differences in the strength of the adhesive composites K2 through K4 within the range of the standard deviation. Only K1 exhibits significantly reduced tensile shear strength, which in turn is due to increased cohesion in the non-cured state, caused by the use of the modified aliphatic cross-linking agent and the associated poorer wetting of the substrates.

The tensile shear strength values of the adhesive films show significant differences for the use of amines or amides as curing agents that cross-link at room temperature. The amides in adhesive composites K1 through K3 show no difference in terms of strength within the range of the standard deviation. Adhesive composite K4, however, exhibits significantly reduced tensile strength, which is due to the phenalkamide curing agent.

| Example: | K5 | K6 | K7 | K8 | K9 |
|---|---|---|---|---|---|
| Adhesive | 0.42 ± 0.13 | 0.25 ± 0.03 | 1.13 ± 0.01 | 1.15 ± 0.01 | 1.15 ± 0.01 |
| strength | (AF/CF) | (AF/CF) | (AF/CF) | (AF/CF) | (AF/CF) |
| [N/mm] | | | | | |
| Tensile shear | 6 ± 1 (AF) | 9 ± 1 (AF) | 30 ± 0 (noF) | 30 ± 0 (noF) | 30 ± 0 (noF) |
| strength [MPa] | | | | | |
| Tensile | 63 ± 1 | 61 ± 1 | 47 ± 1 | 45 ± 1 | 46 ± 1 |
| strength [MPa] | | | | | |

Key: AF: adhesion failure; CF: cohesion Failure; SCF: substrate-related special cohesion failure; noF: no failure as the force limit of the test device was reached.

The adhesive films K5 through K8 all include the same curing agent that cross-links at room temperature, however, they differ in terms of the composition of their epoxy resin components. The adhesive composites K8 and K9 are similar in composition, only the curing agent that cross-links at room temperature was changed.

The adhesive composites K7 through K9 exhibit very similar mechanical properties in respect of adhesive strength, tensile shear strength and tensile strength, both in the non-cured and in the cured state.

The adhesive composites K5 and K6 also exhibit similar mechanical properties. Due to their chemical composition, they exhibit excessive cohesion in the non-cured state, which prevents or negatively affects the development of the adhesive interactions with the substrates. In comparison to the adhesive composites K7 through K9, tensile strength is significantly higher, however, the adhesive composite compositions K5 and K6 are more brittle and will therefore break more easily.

As far as applicable, all individual features shown in the sample embodiments can be combined and/or exchanged without leaving the scope of the invention.

1. A pressure-sensitive structural adhesive film based on an epoxy resin composition, the epoxy resin composition comprising:
a latent reactive, thermally activatable curing agent for producing a structural composite after thermal curing; and
curing agent that crosslinks at room temperature.

2. The pressure-sensitive structural adhesive film of claim 1, wherein the epoxy resin composition includes components comprising:
30 to 95% by weight of at least one epoxy component,
0.1 to 80% by weight of at least one thermally activatable curing agent,
0.1 to 90% by weight of at least one curing agent that crosslinks at room temperature,
0 to 70% by weight of at least one accelerant, and
0 to 70% by weight of at least one additive; and
wherein the percentage by weight of the components add up to 100%.

3. The pressure-sensitive structural adhesive film of claim 1, wherein the curing agent that crosslinks at room temperature comprises at least one component selected from the group consisting essentially of an amine, an amide, a phenalkamine, a phenalkamide and a thiol.

4. The pressure-sensitive structural adhesive film of claim 1, wherein an adhesive strength in a non-cured state amounts to at least 0.2 N/mm.

5. The pressure-sensitive structural adhesive film of claim 1, wherein the adhesive film is for forming a transfer film and is without a backing.

6. The pressure sensitive structural adhesive film of claim 1, wherein the adhesive film comprises a backing.

7. The pressure-sensitive structural adhesive film of claim 1, wherein the adhesive film has a thickness between 1 μm and 3000 μm.

8. (canceled)

9. (canceled)

10. The pressure-sensitive structural adhesive film of claim 7, wherein the adhesive film has a thickness in the range between 10 μm and 2000 μm.

11. The pressure-sensitive structural adhesive film of claim 7, wherein the adhesive film has a thickness in the range between 50 μm and 1000 μm

12. The pressure-sensitive structural adhesive film of claim 1, wherein the at least one epoxy component comprises at least 10% by weight, preferably.

13. The pressure-sensitive structural adhesive film of claim 1, wherein the at least one epoxy component comprises between 20% by weight to 95% by weight of epoxy resin liquid at 25° C.

14. The pressure-sensitive structural adhesive of claim 1, wherein the latent reactive composition comprises 1% to 50% of the curing agent that crosslinks at room temperature in relation to an epoxy equivalent weight of all the epoxy resins or materials including the epoxy used.
